(19) United States
(12) Patent Application Publication
(10) Pub. No.: US 2019/0305980 A1
(43) Pub. Date: Oct. 3, 2019

(54) COMMUNICATIONS ADAPTER APPARATUS FOR INTERFACING WITH AN APPLIANCE CONTROLLER

(71) Applicant: Electrolux Home Products, Inc., Charlotte, NC (US)

(72) Inventor: Mario D'Ovidio, Cornelius, NC (US)

(73) Assignee: Electrolux Home Products, Inc., Charlotte, NC (US)

(21) Appl. No.: 16/369,154

(22) Filed: Mar. 29, 2019

Related U.S. Application Data
(60) Provisional application No. 62/649,944, filed on Mar. 29, 2018.

(51) Int. Cl. H04L 12/28; G06F 9/30; H04L 29/02

(52) U.S. Cl. CPC H04L 12/2816; H04L 2012/285; H04L 29/02; G06F 9/3004

(57) ABSTRACT

A communications adapter may be in operative communication with the controller of the appliance via a connector, cable, or wire configured to send and/or receive electrical signals, data, and/or power. Through the connector, the communications adapter may be configured to retrieve various types of appliance data (both real-time and static data) from the appliance controller. The communications adapter may then wirelessly communicate with a user device to relay the appliance data and receive user inputs. In this manner, the communications adapter provides a way to retrofit legacy appliances with wireless communication capabilities, which in turn enables the user to remotely monitor and control the appliances.

### CROSS-REFERENCE TO PRIORITY APPLICATION

This application claims priority to Provisional Application No. 62/649,944 entitled “COMMUNICATIONS ADAPTER APPARATUS FOR INTERFACING WITH AN APPLIANCE CONTROLLER” filed Mar. 29, 2018, the contents of which are hereby incorporated by reference in its entirety.

### FIELD OF THE INVENTION

The present disclosure embraces a communications adapter for interfacing with an appliance and a method for using said adapter to interface with an appliance. In particular, the adapter may allow for the retrofitting of wireless communication capability as well as remote control and data retrieval functions to existing appliances through an electrical connection to the appliance's controller.

### BACKGROUND

Many appliances currently in use lack the hardware and/or software necessary to communicate with external devices or applications. Accordingly, there exists a need for appliances with networking and computing functionality.

### BRIEF SUMMARY

The disclosure presents a novel communications adapter that connects to a controller of an appliance to provide wireless communication capabilities for the appliance. The communications adapter may be in operative communication with the controller of the appliance via a connector, cable, or wire configured to send and/or receive electrical signals, data, and/or power. Through the connector, the communications adapter may be configured to retrieve various types of appliance data (both real-time and static data) from the appliance controller. The communications adapter may then wirelessly communicate with a user device to relay the appliance data and receive user inputs. In this manner, the communications adapter provides a way to retrofit legacy appliances with wireless communication capabilities, which in turn enables the user to remotely monitor and control the appliances.

Accordingly, embodiments of the present disclosure provide a communications adapter apparatus for interfacing with an appliance. The apparatus may comprise a processor; a connector structured to operatively connect the apparatus to a controller of the appliance; a communication interface; and a memory having executable code stored thereon. The executable code, when executed by the processor, may cause the processor to determine an identity of the appliance or the controller of the appliance; establish a first communication channel with the controller of the appliance, wherein the first communication channel provides data transmission and retrieval between the apparatus and the controller of the appliance; and establish a second communication channel with a user device, wherein the second communication channel provides data transmission and retrieval between the apparatus and the user device.

In some embodiments, the executable code further causes the processor to access a database of appliance configuration profiles; and based on the identity of the appliance or the controller of the appliance, select an appliance configuration profile corresponding with the appliance.

In some embodiments, determining the identity of the appliance or the controller of the appliance comprises transmitting a query to the controller of the appliance, wherein the query comprises a request for the controller of the appliance to identify itself; and receiving a response from the controller of the appliance, wherein the response comprises the identity of the appliance or the controller of the appliance.

In some embodiments, determining the identity of the appliance or the controller of the appliance comprises receiving, via the user device, an input from a user, wherein the input comprises information regarding the identity of the appliance or the controller of the appliance.

In some embodiments, the executable code further causes the processor to receive, from the user device, a request to change a configuration of the appliance; and transmit, to the controller of the appliance, a command to change the configuration of the appliance.

In some embodiments, the appliance is a refrigerator. In such embodiments, the command to change the configuration of the appliance comprises changing one of a temperature setting, an internal light setting, or a power setting of the refrigerator.

In some embodiments, the appliance is an oven. In such embodiments, the command to change the configuration of the appliance comprises changing one of a temperature setting, a timer setting, or a power setting of the oven.

In some embodiments, the appliance is a washer. In such embodiments, the command to change the configuration of the appliance comprises changing one of a wash cycle setting, a water temperature setting, or a garment color setting of the washer.

In some embodiments, the executable code further causes the processor to receive, from the user device, a request to retrieve a set of data from the controller of the appliance, wherein the set of data comprises a parameter associated with the appliance; retrieve the set of data from the controller of the appliance; and transmit the set of data to the user device.

In some embodiments, the appliance is a refrigerator. In such embodiments, the parameter associated with the appliance comprises one of a current temperature, internal light status, or a power status of the refrigerator.

In some embodiments, the appliance is an oven. In such embodiments, the parameter associated with the appliance comprises one of a current temperature, timer status, or power status of the oven.

In some embodiments, the appliance is a washer. In such embodiments, the parameter associated with the appliance comprises one of a wash cycle status, current water temperature, or power status of the washer.

In some embodiments, the apparatus further comprises an interactive display configured to accept an input from a user, wherein the input comprises a command to change a configuration of the appliance; and display a parameter associated with the appliance.

Embodiments of the present disclosure also provide a computer-implemented method for interfacing with an appliance. The method may comprise connecting a communications adapter apparatus to the appliance via a connector; determining, via the apparatus, an identity of the appliance or a controller of the appliance; establishing, via the apparatus, a first communication channel with the controller of the appliance, wherein the first communication channel provides data transmission and retrieval between the apparatus and the controller of the appliance; and establishing, via the apparatus, a second communication channel with a user device, wherein the second communication channel provides data transmission and retrieval between the apparatus and the user device.

In some embodiments, the method further comprises accessing, via the apparatus, a database of appliance configuration profiles; and based on the identity of the appliance or the controller of the appliance, selecting, via the apparatus, an appliance configuration profile corresponding with the appliance.

In some embodiments, determining the identity of the appliance or the controller of the appliance comprises transmitting a query to the controller of the appliance, wherein the query comprises a request for the controller of the appliance to identify itself; and receiving a response from the controller of the appliance, wherein the response comprises the identity of the appliance or the controller of the appliance.

In some embodiments, determining the identity of the controller of the appliance comprises receiving, via the user device, an input from a user, wherein the input comprises information regarding the identity of the appliance or the controller of the appliance.

In some embodiments, the method further comprises receiving, from the user device, a request to change a configuration of the appliance; transmitting, to the controller of the appliance, a command to change the configuration of the appliance; receiving, from the user device, a request to retrieve a set of data from the controller of the appliance, wherein the set of data comprises a parameter associated with the appliance; retrieving the set of data from the controller of the appliance; and transmitting the set of data to the user device.

Embodiments of the present disclosure also provide a system for interfacing with appliances. The system may comprise an appliance comprising a controller and a communications adapter apparatus retrofitted to the controller of the appliance via a connector. The apparatus may comprise a processor; a communication interface; and a memory having executable code stored thereon. The executable code, when executed by the processor, may cause the processor to determine an identity of the appliance or the controller of the appliance; establish a first communication channel with the controller of the appliance, wherein the first communication channel provides data transmission and retrieval between the apparatus and the controller of the appliance; and establish a second communication channel with a user device, wherein the second communication channel provides data transmission and retrieval between the apparatus and the user device.

In some embodiments, the appliance is a major appliance. The major appliance may be, for instance, a refrigerator, freezer, stove, microwave, washing machine, dryer, dishwasher, air conditioner, or water heater.

The features, functions, and advantages that have been discussed may be achieved independently in various embodiments of the present invention or may be combined with yet other embodiments, further details of which can be seen with reference to the following description and drawings.

### BRIEF DESCRIPTIONS OF THE DRAWINGS

FIG. 1 illustrates an operating environment for the retrofit communications adapter, in accordance with some embodiments;

FIG. 2 is a block diagram illustrating the communications adapter, the appliance controller, the user device, and the database device in more detail, in accordance with some embodiments; and

FIG. 3 illustrates a process flow diagram for the communications adapter, in accordance with some embodiments.

### DETAILED DESCRIPTION OF EMBODIMENTS OF THE DISCLOSURE

Embodiments of the present disclosure provide a communications adapter that connects to a controller of an appliance (“appliance controller”) to provide wireless communication capabilities for the appliance. The communications adapter may be in operative communication with the controller of the appliance via a connector, cable, or wire configured to send and/or receive electrical signals, data, and/or power. In some embodiments, said connector, cable, or wire may be a cable harness or wire harness that may be configured to connect the appropriate electrical pins on the communications adapter to the corresponding electrical pins of the appliance controller (e.g., via an interface on or within the appliance controller, such as a diagnostic port, communications port, or the like). Through the connector, the communications adapter may be configured to retrieve various types of appliance data (both real-time and static data) from the appliance controller. For example, if the appliance is a refrigerator, the appliance data may include the temperature setting of the refrigerator, the measured internal temperature of the refrigerator, whether the refrigerator is powered on or off, or the like. If the appliance is an oven, the appliance data may include the temperature setting of the oven, the measured internal temperature of the oven, the status of the oven (e.g., on or off), the status of the interior oven light, or the like.

In some embodiments, the communications adapter may further be configured to issue commands to the appliance controller through the connector in addition to being configured to retrieve appliance data. For example, if the appliance is a washing machine, the communications adapter may be configured to, by sending electric signals to the appliance controller through the connector, issue commands to the washing machine, such as changes in a wash cycle setting (e.g., cottons, delicates, or the like), a water temperature setting, a garment color setting, or the like. If the appliance is a toaster oven, the communications adapter may issue commands such as changes in a temperature setting, a timer setting, a convection setting, an internal light setting, or the like. In some embodiments, the communications adapter may comprise a user interface comprising an interactive display that may be configured to display appliance data and receive control inputs from the user. In such embodiments, the interactive display may be a touchscreen, an integrated monitor or screen paired with an input device such as a keyboard or touchpad, or the like, through which the user may control the appliance (e.g., adjust settings or a configuration of the appliance).

In other embodiments, the communications adapter may comprise a communication interface such as a network adapter that is configured to communicate with an external user device such as a smartphone, laptop, desktop computer, tablet, Internet-of-Things (IoT) device, or the like. The network adapter may comprise a wireless network adapter configured to communicate with the user device via a wireless connection (e.g., WiFi, Bluetooth, or other wireless communications protocols) and/or a wired network adapter configured to communicate with the user device via a wired connection (e.g., Ethernet, USB, or other data cable). Accordingly, the user device may be operatively connected to the communications adapter via wired, wireless, or a combination of wired and wireless connections.

The user device may comprise a user application which may be configured to display appliance data as well as receive control inputs from the user. In such embodiments, the user may, through the user device, retrieve appliance data (e.g., appliance status, settings, condition, or the like) and control the appliance (e.g., adjust settings or a configuration of the appliance) by interacting with the appliance controller via the communications adapter. In this way, the communications adapter may provide a user with the ability to, through the user device, obtain appliance data and control the appliance in real time from a remote location. For example, the user device may control the appliance when the user device and appliance are located in separate rooms within a building (e.g., via a local network), or when the user device is located outside of the building (e.g., via the Internet).

The communications adapter may be configured to, via the connector, cable, or wire, detect the identity of the appliance controller. Based on the identity of the appliance controller, the communications adapter may select the appropriate communications protocol to enable the communications adapter to send and receive electric signals to and from the appliance controller. For instance, an appliance controller for a particular appliance (e.g., a particular make and model of refrigerator) may be configured to use a certain configuration of pins to control its electric inputs and outputs. Upon identifying the particular appliance controller, the communications adapter may adjust its communications protocol (e.g., the mapping of appropriate pins for inputs and outputs) to recognize the data retrieved from the appliance controller and issue valid commands to the appliance controller. In some embodiments, the communications adapter may be configured to identify the appliance controller by sending a query to the appliance controller that contains a request for the appliance controller to identify itself. Based on the response received from the appliance controller, the communications adapter may match the identity of the appliance controller with a list of known appliance controllers, which may exist within an internal or external database.

In other embodiments, the communications adapter may automatically select the appropriate communications protocol based on detecting a specific configuration of the appliance controller. For instance, if a particular appliance controller uses a unique configuration of input/output pins, the communications adapter may be able to recognize said unique configuration to specifically identify the appliance controller. In further embodiments, the user may be able to manually provide the identity of the appliance controller and/or appliance via the user application on the user device, the interactive display integrated into the communications adapter, or other methods.

In an exemplary embodiment, the user may wish to enable wireless connectivity for an oven owned by the user. The communications adapter may be installed by coupling the communications adapter to the appliance controller via a connector, such as an electric and/or data cable. The user may, through a user device, such as a smartphone, connect to the appliance controller through the communications adapter via a wireless connection, such as a Wi-Fi or Bluetooth connection. The user device may communicate with the communications adapter to change various settings within the communications adapter. For instance, the user may provide the make and model of the appliance to allow the communications adapter to communicate with the appliance controller. Once the communications adapter has established a communication channel with the appliance controller (e.g., by selecting the correct communication protocol associated with the appliance), the user may be able to use the user device to view various types of information about the oven, such as whether the oven is turned on or off, the oven's current temperature, the status of the oven's internal light, diagnostic information, timer information (e.g., the amount of cooking time remaining) or the like. In addition, the user may also be able to issue commands to the appliance controller via the communications adapter, such as commands that change oven temperature, timer settings, cooking profiles, or the like. In this way, the communications adapter may allow for the retrofitting of “smart” features (e.g., wired or wireless remote connectivity, automated execution of processes, and other computing functions) to appliances that do not inherently possess such features.

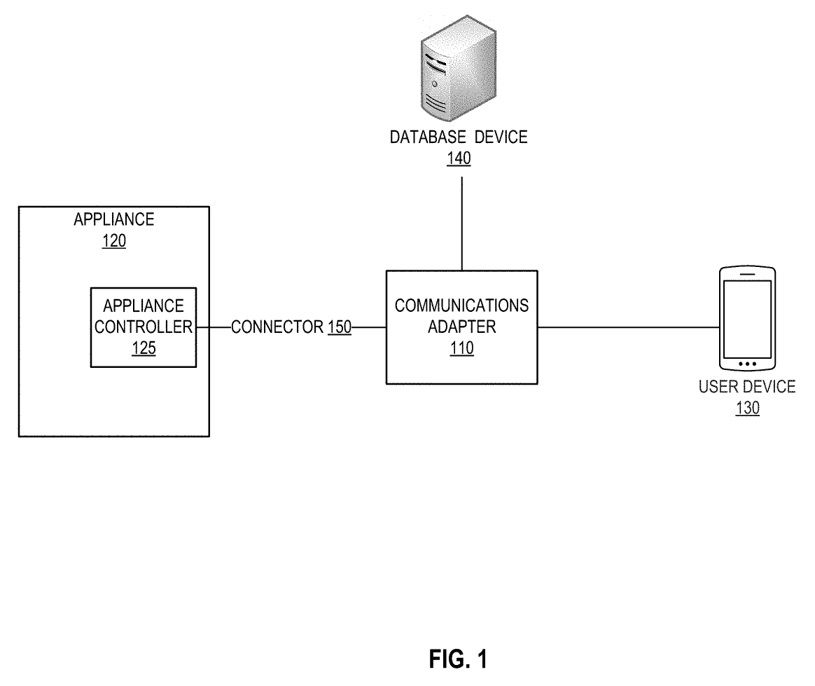

FIG. 1 shows an operating environment for the communications adapter 110, in accordance with some embodiments. The communications adapter 110 may be in operative communication with an appliance 120 through a connector 150 (e.g., an electrical connector, cable, or wire) linked to the appliance controller 125. The connector 150 may be a wired connection such as a wiring or cable harness, data cable, or the like. In some embodiments, the communications adapter 110 may be powered through an independent power source (e.g., a power supply such as a power adapter, battery, or the like). In other embodiments, the communications adapter 110 may be powered through the electrical connector linked to the appliance controller 125.

“Appliance” as used herein may refer to various devices or apparatuses which may be used in a home or office setting to perform specific functions. In some embodiments, the appliance 120 is a major appliance such as a refrigerator, freezer, stove, microwave, washing machine, dryer, dishwasher, air conditioner, or water heater. Each appliance 120 may comprise an appliance controller 125 which may be configured to detect various conditions of the appliance 120 and control the various functions of the appliance 120. For instance, if the appliance 120 is a refrigerator, the appliance controller 125 may detect conditions such as the temperature of the refrigerator, current temperature setting, the status of internal lights, coolant levels, or the like. If the appliance 120 is an oven, the appliance controller 125 may detect conditions such as current oven temperature, temperature setting, timer setting, current time, or the like.

In some embodiments, the appliance controller 125 may further be able to adjust various settings or configurations of the appliance. For instance, if the appliance 120 is a microwave, the appliance controller 125 may be configured to adjust heat settings, timer settings, clock settings, preset heating profiles, or the like based on user input. If the appliance 120 is a washing machine, the appliance controller 125 may be configured to adjust wash cycles, timer settings, water temperature settings, preset washer profiles, or the like based on user input. The appliance controller 125 may receive user inputs through the appliance itself, such as through an interface on the appliance (e.g., temperature dials/buttons, on/off switch, etc.). Accordingly, in some embodiments, the communications adapter 110 may be configured to provide user inputs to the appliance controller 125 through the connector 150, where the user inputs may be received from the user via the user device 130 and/or within an interface on the communications adapter 110. In this way, the communications adapter 110 allows the user to provide inputs to the appliance controller 125 using interfaces (e.g., the user device 130) other than the interface found on the appliance 120.

The user device 130 may be an external electronic device owned and/or operated by the user. Accordingly, the user device 130 may be a laptop or desktop computer, smartphone, tablet, smart device, IoT device, single-board computer (SBC), or the like. The user device 130 may be in operative communication with the communications adapter 110 via a wireless communication channel such as a cellular network, Wi-Fi network, Bluetooth connection, NFC connection, or the like, or any combination thereof. In other embodiments, the user device 130 may be in operative communication with the communications adapter 110 via a wired communication channel, such as a USB cable, Ethernet cable, or other type of wired data connection. In this way, the user may use the user device 130 to transmit inputs to and receive outputs from the appliance controller 125 via the communications adapter 110, which may allow the user to remotely view appliance data for a particular appliance (e.g., information about the state of the appliance) as well as issue commands to change settings or a configuration of the appliance.

The communications adapter 110 may, in some embodiments, be in operative communication with a database device 140. The database device 140 may be an external database to which the communications adapter 110 is connected via a network, or the database device 140 may be an internal device (e.g., a data storage device) within the communications adapter 110. The database device 140 may comprise a list of devices (e.g., appliances) along with unique configuration profiles for each appliance. As used herein, “configuration profile” may refer to a set of information and/or instructions which may be read and/or executed by the communications adapter 110 to communicate with a specific appliance or appliance controller 125 or a subset thereof. In this regard, the configuration profile may contain information such as communication protocols supported by the appliance, data formatting rules, address formatting rules, data mapping rules, metadata information, or the like.

By retrieving and loading the configuration profile associated with a particular appliance, the communications adapter 110 may select the appropriate communications protocol for retrieving and sending data through the connector 150 in communicating with the appliance controller 125. In some embodiments, the communications adapter 110 may automatically select an appliance configuration profile based on querying the appliance controller 125 or by detecting a unique state of the appliance controller 125 as described above. In other embodiments, the communications adapter 110 may manually be configured according to an appliance configuration profile based on user input (e.g., the user selects the make and/or model of appliance into which the communications adapter 110 is to be installed, which in turn causes the communications adapter 110 to select a configuration profile associated with the user selected appliance).

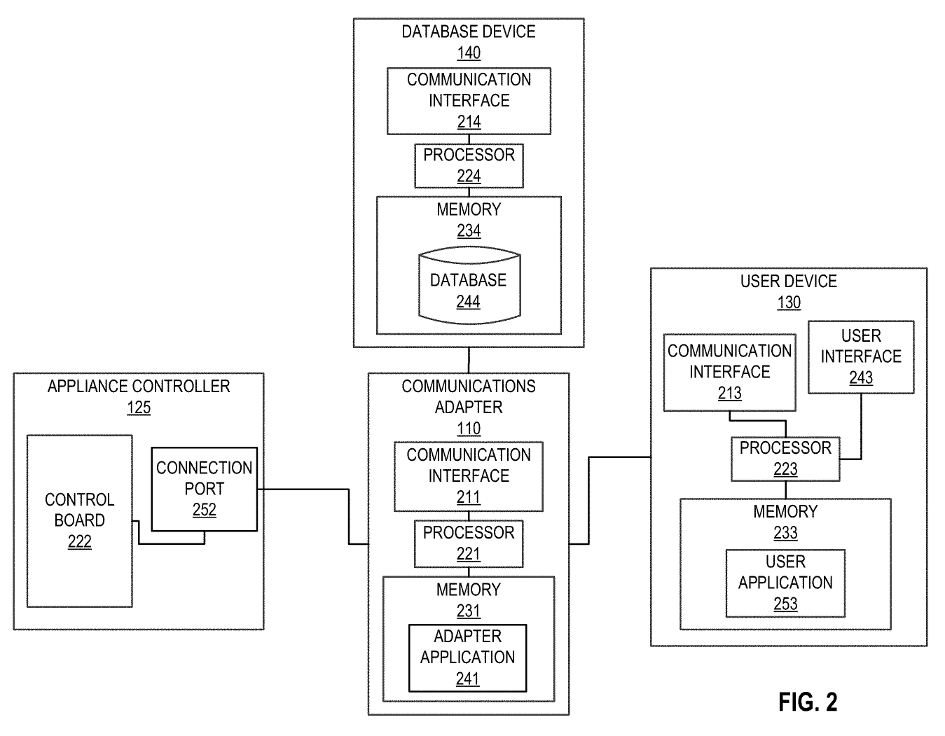

FIG. 2 is a block diagram illustrating the communications adapter 110, the appliance controller 125, the user device 130, and the database device 140 in more detail, in accordance with some embodiments. The communications adapter 110 may be in operative communication with one or more other devices as shown in FIG. 2 over a network. “Network” as used herein may refer to a global area network (GAN), such as the Internet, a wide area network (WAN), a local area network (LAN), or any other type of network or combination of networks. The network may provide for wireline, wireless, or a combination wireline and wireless communication between devices on the network. The communications adapter 110 may comprise a processor 221 communicably coupled to such devices as a communication interface 211 and a memory 231. The processor 221, and other processors described herein, typically includes circuitry for implementing communication and/or logic functions. For example, the processor 221 may include a digital signal processor device, a microprocessor device, and various analog to digital converters, digital to analog converters, and/or other support circuits. The communications adapter 110 may use the communication interface 211 to communicate with other devices over the network. “Communication interface” as used herein may include an Ethernet interface, an antenna coupled to a transceiver configured to operate on a cellular data, GPS, or WiFi signal, and/or a near field communication (“NFC”) interface. In some embodiments, a processing device, memory, and communication device may be components of a controller, where the controller executes one or more functions based on the code stored within the memory.

As used herein, “memory” includes any computer readable medium (as defined herein below) configured to store data, code, or other information. The memory may include volatile memory, such as volatile Random Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like. The memory 231 may have an adapter application 241 stored thereon, where the adapter application 241 contains the code and/or logic to retrieve data from the appliance controller 125, send outputs and receive inputs to and from the user device 130, access and execute appliance configuration profiles, and/or send commands to the appliance controller 125, among other functions.

Typically, the communications adapter 110 is in operative communication with the appliance controller 125 through a connection port 252 which is communicatively coupled with a control board 222 within the appliance controller 125. In some embodiments, the appliance 120 may further comprise a data transfer cable which connects the connection port 252 to the control board 222 of the appliance controller 125. The connection port 252 may be, for example, an electrical socket, data port, slot, or other type of connection point which facilitates the input and output of electrical signals and/or data. For instance, the connection port 252 may be a USB port, USB micro or mini port, USB type-C port, Thunderbolt port, or the like. The control board 222 may comprise various controllers, resistors, capacitors, transformers, switches, fuses, wires, or the like, which allow the appliance controller 125 to receive information about the appliance (e.g., the internal temperature reading from a thermometer) and/or create changes in configuration in the appliance (e.g., an actuation of a solenoid to allow water to flow into a washing machine). By determining the identity of the appliance controller 125 and/or the appliance itself, the communications adapter 110 may be able to determine the configuration of the control board 222 and/or the connection port 252, which will in turn allow the communications adapter to select the correct communications protocol to communicate with the control board 222 of the appliance controller 125.

The appliance 120 may comprise a power supply cable which connects the appliance 120 to a power source (e.g., electrical outlet) to provide power to the appliance 120 and/or the appliance controller 125. In other embodiments, the appliance 120 may comprise a portable power supply (e.g., a battery). The data transfer cable may be integrated with the power supply cable of the appliance such that the data transfer cable runs adjacent to and alongside the power supply cable. In such embodiments, the connection port 252 may be a terminal point of the data transfer cable which is located near the end of the power supply cable that connects to the power source. For example, the connection port 252 may be a USB port that is integrated into a transformer of the power supply cable. In such embodiments, the communications adapter 110 may, through the connector 150 (e.g., a USB cable), be operatively linked to the connection port 252 (e.g., a USB port), which may be external to the appliance 120, to allow the communications adapter 110 to communicate with the control board 222 of the appliance controller 125.

The user device 130 may comprise a processor 223 communicatively coupled with a communication interface 213 and a memory 233 having a user application 253 stored thereon. The user application 253 may allow the user to view information about the appliance (e.g., the current state of the appliance) and/or issue commands to the communications adapter 110 and/or the appliance controller 125. The user device 130 may further comprise a user interface 243 which serves to interact with the user. The user interface 243 may comprise the hardware and software implements to accept input from and provide output to the user. Accordingly, the user interface 243 may comprise hardware such as a display, audio output devices, projectors, and the like, or input devices such as keyboards, mice, sensors, cameras, microphones, biometric input devices (e.g., fingerprint readers), and the like. The user interface 243 may further comprise software such as a graphical or command-line interface through which the user may provide inputs and/or receive outputs from the user device 130, which then allows the user to communicate with the communications adapter 110 and/or the appliance controller 125. It should be understood that the display on which the user interface 243 is presented may include an integrated display (e.g. a tablet or smartphone screen) within the user device 130, or an external display device (e.g. a computer monitor or television).

The communications adapter 110 may further be in operative communication with a database device 140. In embodiments in which the database device 140 is an external system, the database device 140 may comprise a processor 224 communicatively coupled with a communication interface 214 and a memory 234 having a database 244 stored thereon. The database 244 may comprise a list of supported appliances or devices along with unique configurations (e.g., appliance configuration profiles) for each appliance or device. The communications adapter 110 may pull data from the database 244 and access the configuration profiles when identifying the appliance controller 125 and determining the appropriate communications protocol to communicate with the appliance controller 125. It should be understood that while the database device 140 is depicted in FIG. 2 as a separate system, it is within the scope of the disclosure for any or all of the components of the database device 140 and/or the database 244 to be an integrated part of the communications adapter 110. For example, the database 244 may be stored within the memory 231 of the communications adapter 110.

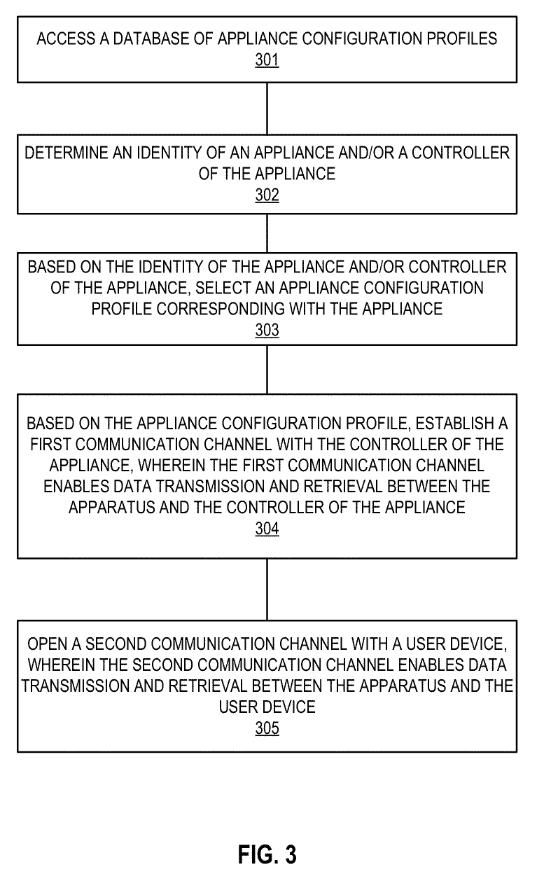

FIG. 3 illustrates a process flow for the communications adapter, in accordance with some embodiments of the present disclosure. The process begins at block 301, where the apparatus accesses a database of appliance configuration profiles. In particular, the database may comprise identifying information associated with a number of appliances (e.g., make, model, appliance type, or the like). The identifying information for each appliance may be associated with an appliance configuration profile, where the configuration profile comprises electronic instructions that allow the apparatus to communicate with the controller of the particular appliance associated with the specific configuration profile.

The process continues to block 302, where the apparatus determines an identity of an appliance and/or a controller of the appliance. In some embodiments, the apparatus may automatically determine the identity of the appliance and/or controller by transmitting a query to the controller, where the query contains a request for the controller to identify itself. In such embodiments, the controller may transmit a response to the query, where the response contains information related to the identity of the controller. In other embodiments, the apparatus may manually determine the identity of the appliance and/or controller based on user input. In such embodiments, the apparatus may receive an input from a user via a user device, where the input contains information regarding the identity of the controller of the appliance and/or of the appliance itself. For instance, the user may provide a selection of a make and model of the appliance in which the retrofit communications adapter is to be installed, which in turn allows the communications adapter to identify both the appliance itself as well as the controller therein.

The process continues to block 303, where the apparatus, based on the identity of the appliance and/or the controller of the appliance, selects an appliance configuration profile corresponding with the appliance. Once the apparatus has identified the controller, the apparatus may match the identity of the controller with an appliance configuration profile within the database. As described above, the appliance configuration profile may enable the apparatus to communicate with the appliance. In particular, the appliance configuration profile may allow the apparatus to select an appropriate communications protocol to send and receive the correct types of electrical signals from the appliance controller to allow the communication to occur.

The process continues to block 304, where the apparatus, based on the appliance configuration profile, establishes a first communication channel with the controller of the appliance, wherein the first communication channel provides data transmission and retrieval between the apparatus and the controller of the appliance. Through the first communication channel, the apparatus may be able to send commands to the appliance controller and receive data from the appliance controller. For instance, the apparatus may, via the first communication channel, transmit a command to change a configuration of a particular appliance depending on the appliance type. A number of exemplary use cases follows. If the appliance is a refrigerator, for instance, the command may include a change to the refrigerator's temperature setting, internal light setting (e.g., brightness, on or off, or the like), or a power setting (e.g., on or off). If the appliance is an oven, the command may include a change in the oven's temperature setting, timer setting, or power setting. If the appliance is a washer, the command may include a change in the washer's wash cycle setting, water temperature setting, or garment color setting.

The apparatus may also receive, via the first communication channel, various types of data from the appliance controller. In particular, the appliance controller may provide data relating to the current status or setting of the appliance. For instance, if the appliance is a refrigerator, the data provided by the appliance controller may include a current temperature, internal light status, or power status of the refrigerator. If the appliance is an oven, the data may include a current temperature, current timer status, or power status of the oven. If the appliance is a washer, the data may include a wash cycle status, current water temperature, timer status, or power status of the washer. It should be appreciated that the foregoing examples are provided for illustrative purposes and that the scope of the functions of the adapter apparatus should not be construed to be limited to the appliances, data sets, or commands as described herein.

The process concludes at block 305, where the apparatus opens a second communication channel with a user device, wherein the second communication channel provides data transmission and retrieval between the apparatus and the user device. Through the second communication channel, the apparatus may receive commands from the user device to be sent to the appliance controller and transmit appliance-related data to the user device. In this way, the apparatus provides the user, via the first communication channel in combination with the second communication channel, an interface through which the user may issue commands to an appliance and receive status data from the appliance from a remote location, even in cases in which the appliance was not originally manufactured with interfacing capabilities.

In some embodiments, the apparatus may perform data formatting processes on data received from the appliance and transmitted to the user device and/or data received from the user device and transmitted to the appliance. For instance, when receiving input data from the user device (e.g., commands to change a configuration of the appliance), the apparatus may transform the input data into an appropriate format such that the input data is recognized and understood by the appliance. In an exemplary embodiment, the user input data may include a command to change a temperature setting of an oven. In such an embodiment, the apparatus may transform the input data into a format that may be recognized by the oven as a command to change the temperature setting.

Furthermore, the apparatus may also transform data received from the appliance (e.g., appliance status data) into a format that may be recognized and understood by the user device. In an exemplary embodiment, the user may request current operating parameters from an appliance such as a refrigerator. The apparatus may receive operating parameters such as a current temperature setting, current actual temperature, power consumption rate, internal light status, or the like. Upon receiving such parameters, the apparatus may format the data such that the user device may recognize the operating parameters from the data, thereby allowing the user device to correctly display the various parameters to the user.

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to provide wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Although certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A communications adapter apparatus for interfacing with an appliance, the apparatus comprising:
a processor;
a connector structured to operatively connect the apparatus to a controller of the appliance;
a communication interface; and
a memory having executable code stored thereon, wherein the executable code, when executed by the processor, causes the processor to:
determine an identity of the appliance or the controller of the appliance;
establish a first communication channel with the controller of the appliance, wherein the first communication channel provides data transmission and retrieval between the apparatus and the controller of the appliance; and
establish a second communication channel with a user device, wherein the second communication channel provides data transmission and retrieval between the apparatus and the user device.

2. The apparatus of claim 1, wherein the executable code further causes the processor to:
access a database of appliance configuration profiles; and
based on the identity of the appliance or the controller of the appliance, select an appliance configuration profile corresponding with the appliance.

3. The apparatus of claim 1, wherein determining the identity of the appliance or the controller of the appliance comprises:
transmitting a query to the controller of the appliance, wherein the query comprises a request for the controller of the appliance to identify itself; and
receiving a response from the controller of the appliance, wherein the response comprises the identity of the appliance or the controller of the appliance.

4. The apparatus of claim 1, wherein determining the identity of the appliance or the controller of the appliance comprises receiving, via the user device, an input from a user, wherein the input comprises information regarding the identity of the appliance or the controller of the appliance.

5. The apparatus of claim 1, wherein the executable code further causes the processor to:
receive, from the user device, a request to change a configuration of the appliance; and
transmit, to the controller of the appliance, a command to change the configuration of the appliance.

6. The apparatus of claim 5, wherein the appliance is a refrigerator, wherein the command to change the configuration of the appliance comprises changing one of a temperature setting, an internal light setting, or a power setting of the refrigerator.

7. The apparatus of claim 5, wherein the appliance is an oven, wherein the command to change the configuration of the appliance comprises changing one of a temperature setting, a timer setting, or a power setting of the oven.

8. The apparatus of claim 5, wherein the appliance is a washer, wherein the command to change the configuration of the appliance comprises changing one of a wash cycle setting, a water temperature setting, or a garment color setting of the washer.

9. The apparatus of claim 1, wherein the executable code further causes the processor to:
receive, from the user device, a request to retrieve a set of data from the controller of the appliance, wherein the set of data comprises a parameter associated with the appliance;
retrieve the set of data from the controller of the appliance; and
transmit the set of data to the user device.

10. The apparatus of claim 9, wherein the appliance is a refrigerator, wherein the parameter associated with the appliance comprises one of a current temperature, internal light status, or a power status of the refrigerator.

11. The apparatus of claim 9, wherein the appliance is an oven, wherein the parameter associated with the appliance comprises one of a current temperature, timer status, or power status of the oven.

12. The apparatus of claim 9, wherein the appliance is a washer, wherein the parameter associated with the appliance comprises one of a wash cycle status, current water temperature, or power status of the washer.

13. The apparatus of claim 1 further comprising an interactive display, wherein the interactive display is configured to:
accept an input from a user, wherein the input comprises a command to change a configuration of the appliance; and
display a parameter associated with the appliance.

14. A computer-implemented method for interfacing with an appliance, the method comprising:
connecting a communications adapter apparatus to the appliance via a connector;
determining, via the apparatus, an identity of the appliance or a controller of the appliance;
establishing, via the apparatus, a first communication channel with the controller of the appliance, wherein the first communication channel provides data transmission and retrieval between the apparatus and the controller of the appliance; and
establishing, via the apparatus, a second communication channel with a user device, wherein the second communication channel provides data transmission and retrieval between the apparatus and the user device.

15. The computer-implemented method of claim 14, the method further comprising:
accessing, via the apparatus, a database of appliance configuration profiles; and
based on the identity of the appliance or the controller of the appliance, selecting, via the apparatus, an appliance configuration profile corresponding with the appliance.

16. The computer-implemented method of claim 14, wherein determining the identity of the appliance or the controller of the appliance comprises:
transmitting a query to the controller of the appliance, wherein the query comprises a request for the controller of the appliance to identify itself; and
receiving a response from the controller of the appliance, wherein the response comprises the identity of the appliance or the controller of the appliance.

17. The computer-implemented method of claim 14, wherein determining the identity of the controller of the appliance comprises receiving, via the user device, an input from a user, wherein the input comprises information regarding the identity of the appliance or the controller of the appliance.

18. The computer-implemented method of claim 14, the method further comprising:
receiving, from the user device, a request to change a configuration of the appliance;
transmitting, to the controller of the appliance, a command to change the configuration of the appliance;
receiving, from the user device, a request to retrieve a set of data from the controller of the appliance, wherein the set of data comprises a parameter associated with the appliance;
retrieving the set of data from the controller of the appliance; and
transmitting the set of data to the user device.

19. A system for interfacing with appliances, comprising:
an appliance comprising a controller; and
a communications adapter apparatus retrofitted to the controller of the appliance via a connector, wherein the apparatus comprises:
a processor;
a communication interface; and
a memory having executable code stored thereon, wherein the executable code, when executed by the processor, causes the processor to:
determine an identity of the appliance or the controller of the appliance;
establish a first communication channel with the controller of the appliance, wherein the first communication channel provides data transmission and retrieval between the apparatus and the controller of the appliance; and
establish a second communication channel with a user device, wherein the second communication channel provides data transmission and retrieval between the apparatus and the user device.

20. The system of claim 19, wherein the appliance is a major appliance, wherein the major appliance is a refrigerator, freezer, stove, microwave, washing machine, dryer, dishwasher, air conditioner, or water heater.
